(19) United States
(12) Patent Application Publication
(10) Pub. No.: US 2017/0083840 A1
(43) Pub. Date: Mar. 23, 2017

(54) OPTIMIZING GRAIN COLLECTION AND TRANSPORTATION BASED ON ESTIMATED MOISTURE CONTENT

(71) Applicant: INTERNATIONAL BUSINESS MACHINES CORPORATION, Armonk, NY (US)

(72) Inventors: TIMOTHY M. LYNAR, ST. KEW (AU); MELANIE E. ROBERTS, NORTH MELBOURNE (AU); OLIVIA J. SMITH, PARKVILLE (AU)

(21) Appl. No.: 14/858,303

(22) Filed: Sep. 18, 2015

(51) Int. Cl. G06Q 10/06

(52) U.S. Cl. CPC G06Q 10/0637

(57) ABSTRACT

In one embodiment, a computer-implemented method includes obtaining a set of data indicating a local condition in a geographic location of a crop to be harvested. A moisture content of the crop to be harvested is estimated, based on the set of data. The moisture content is balanced against at least one economic constraint in order to maximize a monetary value of the crop to be harvested, using an optimization problem. A plan for harvesting the crop to be harvested is generated by solving the optimization problem. The plan includes a recommended window of time within which to harvest the crop to be harvested.

### BACKGROUND OF THE INVENTION

The present invention relates generally to grain harvesting and relates more specifically to techniques for optimizing the collection, storage, and transportation of grain based on local business and weather conditions.

Maintaining an optimal moisture content for grain and hay is critical for the safe storage and transportation of the product. For instance, if the moisture content is too high, the product may be susceptible to spontaneous combustion or spoilage (e.g., due to fungi and pests). On the other hand, if the moisture content is too low, this may diminish the quality and/or monetary value of the product (e.g., due to shrinkage or weight loss associated with drying).

### SUMMARY OF THE INVENTION

In one embodiment, a computer-implemented method includes obtaining a set of data indicating a local condition in a geographic location of a crop to be harvested. A moisture content of the crop to be harvested is estimated, based on the set of data. The moisture content is balanced against at least one economic constraint in order to maximize a monetary value of the crop to be harvested, using an optimization problem. A plan for harvesting the crop to be harvested is generated by solving the optimization problem. The plan includes a recommended window of time within which to harvest the crop to be harvested.

In another embodiment, a machine-readable storage medium is encoded with instructions executable by a processor. The machine-readable storage medium includes instructions to estimate a moisture content of a crop to be harvested, based on a set of data indicating a local condition in a geographic location of the crop to be harvested, instructions to balance the moisture content against at least one economic constraint in order to maximize a monetary value of the crop to be harvested, using an optimization problem, and instructions to generate a plan for harvesting the crop to be harvested by solving the optimization problem, wherein the plan includes a recommended window of time within which to harvest the crop to be harvested.

In another embodiment, a system includes a set of rules identifying at least one economic constraint relating to a crop to be harvested and a processor for estimating a moisture content of the crop to be harvested, in response to a measured set of data indicating a local condition in a geographic location of the crop to be harvested, for balancing the moisture content against the at least one economic constraint in order to maximize a monetary value of the crop to be harvested, using an optimization problem, and for generating a plan for harvesting the crop to be harvested by solving the optimization problem, wherein the plan includes a recommended window of time within which to harvest the crop to be harvested.

### BRIEF DESCRIPTION OF THE DRAWINGS

So that the manner in which the above recited features of the present invention can be understood in detail, a more particular description of the invention may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating one embodiment of a system for optimizing grain collection based on estimated moisture content, according to the present disclosure;

FIG. 2 is a flow diagram illustrating one example of a high level computer-implemented method for optimizing grain collection based on estimated moisture content;

FIG. 3 is a flow diagram illustrating one example of a more detailed computer-implemented method for optimizing grain collection based on estimated moisture content;

FIG. 4 illustrates a graphic representation of a single crop source and an example graph charting the single crop source's volume and moisture content over time;

FIG. 5 illustrates an example vehicle route that dictates an order in which a vehicle should visit five different sources to accept crops for transport and delivery to a destination; and

FIG. 6, for example, depicts a high-level block diagram of a computer that can be transformed into a machine capable of performing the functions described herein.

### DETAILED DESCRIPTION

In one embodiment, a method, machine readable storage medium, and apparatus for optimizing grain collection based on estimated moisture content is disclosed. Maintaining an optimal moisture content for grain and hay is critical for the safe storage and transportation of the product. It is optimal to transport and store grain at the maximum moisture content for the product's intended use and destination, expected duration of storage, mode of transportation, and product type. Although grain can be dried to the maximum moisture content, the cost of the drying detracts from the net profitability of the crop. On the other hand, legal restrictions make it infeasible to deliberately increase the moisture content post-harvest.

Embodiments of the invention estimate a location and time to harvest grain and other crops in order to maintain an optimal moisture content for transportation and storage. The estimates are based on local business and weather conditions, such as predicted crop quality and moisture content, fine-grained weather predictions, business rules, and market conditions. Embodiments of the invention recognize that the optimal time to harvest grain and other crops to maximize profit is a function of crop maturity, crop quality, crop price, crop demand, availability of local processing, crop transport, crop storage and related business rules, total moisture content of the crop at harvest, and the effect of local conditions during crop transport and storage. Based on these estimates, embodiments of the invention recommend a harvest time for a particular crop, as well as a route by which to transport the harvested crop. One goal of the recommendations is to optimize the profit, for a particular operator, based on business specifics, with respect to the timing of the harvest. The operator may be, for example, a collective of cooperating farm owners, a grain buyer, a grain exporter, or another individual, company, or collective who can influence harvest time.

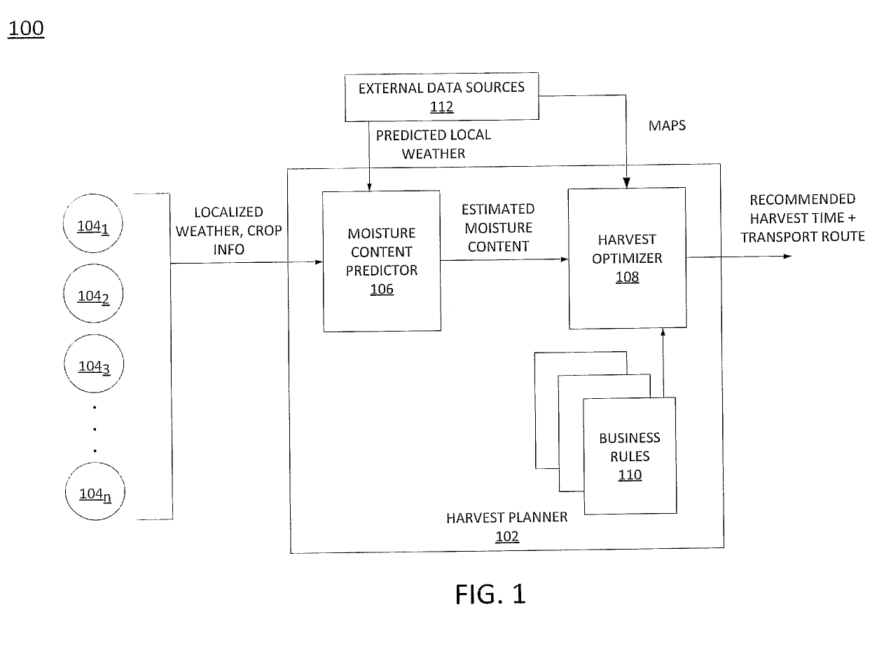

FIG. 1 is a block diagram illustrating one embodiment of a system 100 for optimizing grain collection based on estimated moisture content, according to the present disclosure. As illustrated, the system 100 generally comprises a harvest planner 102 in communication (e.g., over one or more networks) with a plurality of sensors 1041-104. (hereinafter collectively referred to as “sensors 104”) and with one or more external data sources 112.

The sensors 104 are distributed throughout a geographic location associated with a particular crop to be harvested (e.g., grain, hay, etc.). In one embodiment, the sensors 104 include any types of sensors that are capable of collecting data related to the state of the crop to be harvested and to weather conditions in the geographic location of the crop to be harvested. For instance, in one embodiment, the sensors 104 may include one or more of the following: weather stations, rain gauges, anemometers, humidity sensors, and temperature sensors. Thus, the sensors 104 are placed to provide fine-grained weather data that is more localized than a public weather forecast. In one embodiment, at least one of the sensors 104 is portable, i.e., is not fixed relative to a single geographic location, and thus may be moved from one geographic location to another. For instance, a portable sensor may be mounted to an automobile, an unmanned vehicle, or other mobile support.

The harvest planner 102 generally comprises a moisture content predictor 106, a harvest optimizer 108, and a set of business rules 110. The moisture content predictor 106 subscribes to the outputs of the sensors 104 and is further coupled to the external data sources 112. The moisture content predictor 106 may comprise a processing unit or other computing device that processes the sensor outputs and data from the external data sources 112 in order to generate estimates relating to the crop to be harvested. For example, based on localized crop and weather information from the sensors 104 and on predicted local weather information from the external data sources 112, the moisture content generator 106 can estimate the quality and the moisture content of the crop to be harvested. In one embodiment, the moisture content predictor 106 estimates the moisture content of a crop to be harvested based on one or more models that are specific to the crop, to the geographical location in which the crop is grown/harvested, and/or to other factors. Some possible models that may be used to estimate the moisture content of a crop to be harvested are discussed in detail by Atzema, A. J. in “A Model for the Prediction of the Moisture Content of Cereals at Harvesting Time with Realtime Weather Data,” Journal of Agircultural Engineering Resources, vol. 54: 245-256.

The harvest optimizer 108 comprises, for example, a processing unit or computing device that receives the estimated quality and moisture content of the crop to be harvested from the moisture content predictor 106. In addition, the harvest optimizer 108 is further coupled to the set of business rules 110 and to the external data sources 112. The harvest optimizer 108 processes the estimated crop quality, estimated moisture content, external data, and/or the business rules in order to generate a recommended harvest time and transport route for the crop to be harvested. One goal of the recommended harvest time and transport route is to optimize the profit, for a particular operator, based on business specifics, with respect to the timing of the harvest.

The set of business rules 110 includes one or more rules specific to the growth, harvest, transport, storage, and/or sale of the crop to be harvested. For instance, the set of business rules 110 may include or reference contractual obligations for export of the crop to be harvested, market data for the crop to be harvested (e.g., current price or range of prices per unit, factors affecting price per unit, demand, supply, etc.), local and/or hub storage availability, drying options, transport routes, maps, costs for storage, drying, and/or transport, or the like. The set of business rules 110 may also include one or more rules to predict the yield and/or quality of a particular crop at harvest time. These rules may include specific rules employed by the relevant agricultural sector, such as rules relating to approximate time to maturation of the crop and other rules appropriate to the crop, growing/harvest location, and/or agricultural sector. In a further embodiment, the rules may include techniques such as those discussed by Lee et al. in “Pre-harvest Forecasting of County Wheat Yield and Wheat Quality Using Weather Information,” Journal of Agricultural and Forecast Meteorology, vol. 168: 26-35.

The external data sources 112 may include sources of data which are not directly related to the crop to be harvested, but which may influence the determination of when and how to transport the crop to be harvested. For instance, the external data sources 112 may include information about prior local weather predictions, local maps, and other types of data.

Alternative configurations of the system 100 are possible. For instance, in one example, the business rules 110 may be accessed remotely (e.g., over one of more networks) by the harvest optimizer 108. Alternatively, some of the data stored in the external data sources 112 could be stored locally in a memory of the harvest planner 102.

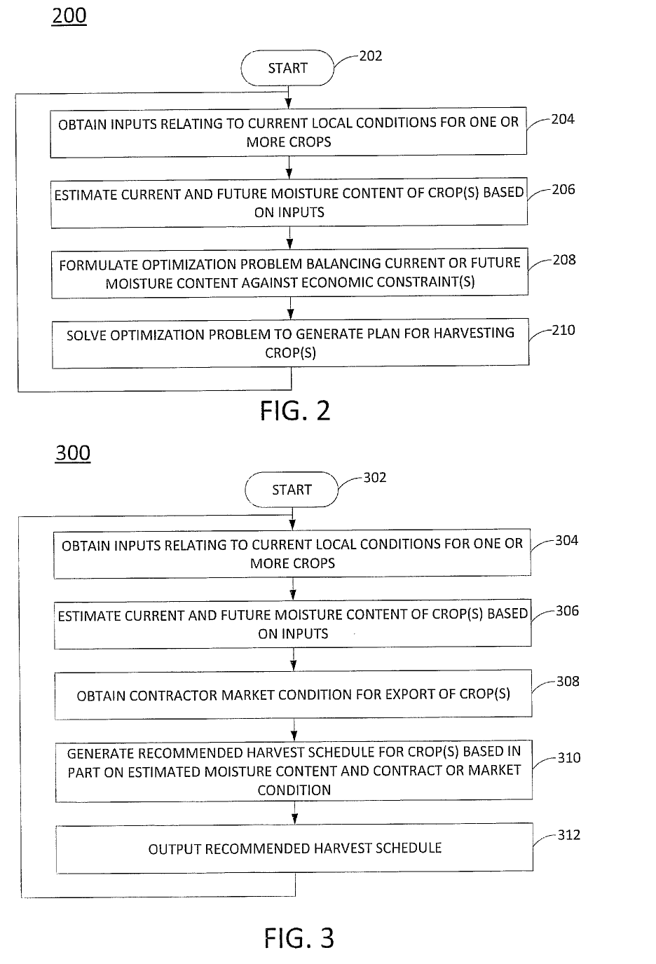

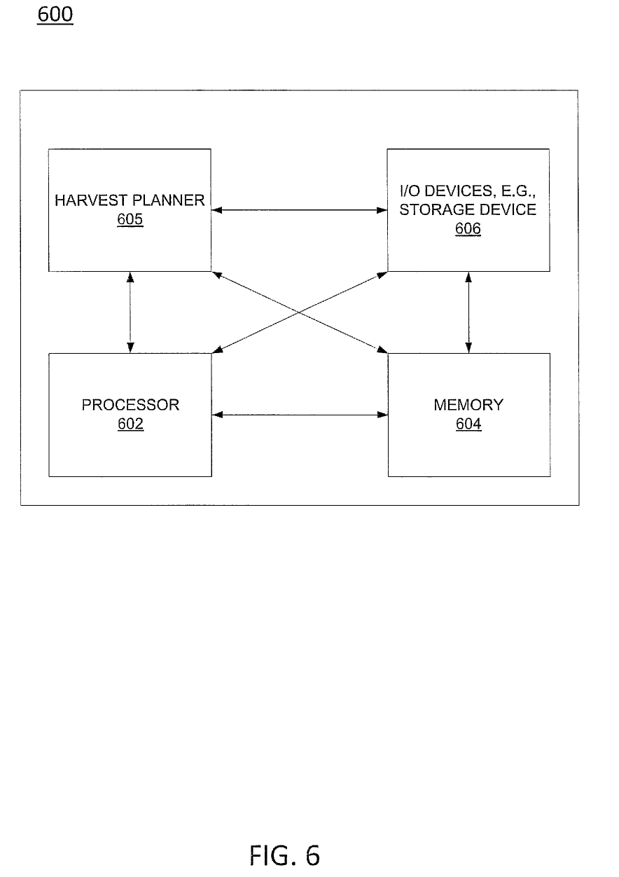

FIG. 2 is a flow diagram illustrating one example of a high level computer-implemented method 200 for optimizing grain collection based on estimated moisture content. The method 200 may be carried out, for example, by various components of the harvest planner 102 illustrated in FIG. 1 and described in detail above, or by a general purpose computer that is programmed to function as special purpose computer, as discussed below in connection with FIG. 6. As an example, the method 200 is described as being performed by components of the harvest planner 102.

The method 200 begins in step 202. In step 204, the moisture content predictor 106 obtains inputs (e.g., sensor readings) from one or more of the sensors 104 and from the external data sources 112. In one embodiment, the moisture content predictor 106 continuously listens to or monitors the sensors 104 and/or external data sources 112 for inputs. The inputs from the sensors may include, for example, data about current local conditions for one or more crops (e.g., grain, wheat, cereal, etc.). The crops may include a number of different crops. For instance, the data may include information about the current crop inventory and current weather conditions in the geographic location or locations where the one or more crops are growing (e.g., temperature, humidity, etc.). The inputs from the external data sources 112 may include, for example, stored data relating to previous predictions, such as predicted future crop inventories and previously measured meteorological data (e.g., previously generated weather forecasts, meteorological changes, large-scale weather models). In one embodiment, the inputs are transmitted from the sensors 104 and external data sources 112 to the moisture content predictor 106 via a network (e.g., pushed to or pulled by the moisture content predictor 106). The inputs may be transmitted periodically (e.g., every x seconds), on-demand (e.g., in response to a request from the moisture content predictor 106), or automatically (e.g., as the inputs become available).

In step 206, the moisture content predictor 106 estimates the current and future moisture content of the one or more crops, based on the inputs obtained in step 204. In one embodiment, the moisture content predictor 106 uses the inputs as inputs into one or more models that estimate moisture content in a manner that is specific to the particular crop(s), to the geographical location in which the particular crop(s) is grown/harvested, and/or other factors. For instance, the models discussed by Atzema may be employed to estimate the current and/or future moisture content.

In step 208, the harvest optimizer 108 formulates an optimization problem that balances the current or future moisture content of the drop to be harvested against at least one economic constraint. The economic constraint may relate, for example, a contractual obligation (e.g., volume or quality of crop to be delivered to a particular destination), a market condition (e.g., current or estimated future market price per unit of the crop), a cost associated with bring the crop to the market (e.g., cost to dry, store, and/or transport the crop), or another crop to be harvested. Thus, the optimization problem may be framed as a mixed integer problem in which the variables represent the decisions that need to be made in relation to harvesting the crop, such as the movement and loading of vehicles for transporting the crop and the quantities of the crop to be harvested in each time period.

In step 210, the harvest optimizer solves the optimization problem to generate a plan for harvesting the crop to be harvested. The plan includes a recommended window of time within which to harvest the crop. Additionally, the plan may include a route along which the crop is to be transported to a destination. The route may include additional stops to receive other crops for delivery to the same or other destinations.

The method 200 then returns to step 204 and awaits the receipt of a new set of inputs.

FIG. 3 is a flow diagram illustrating one example of a more detailed computer-implemented method 300 for optimizing grain collection based on estimated moisture content. The method 300 may be carried out, for example, by various components of the harvest planner 102 illustrated in FIG. 1 and described in detail above, or by a general purpose computer that is programmed to function as special purpose computer, as discussed below in connection with FIG. 6. As an example, the method 300 is described as being performed by components of the harvest planner 102.

The method 300 begins in step 302. In step 304, the moisture content predictor 106 obtains inputs (e.g., sensor readings) from one or more of the sensors 104 and from the external data sources 112. In one embodiment, the moisture content predictor 106 continuously listens to or monitors the sensors 104 and/or external data sources 112 for inputs. The inputs from the sensors may include, for example, data about local conditions for one or more crops (e.g., grain, wheat, cereal, etc.). The crops may include a number of different crops. For instance, the data may include information about the current crop inventory and current weather conditions in the geographic location or locations where the one or more crops are growing (e.g., temperature, humidity, etc.). The inputs from the external data sources 112 may include, for example, stored data relating to previous predictions, such as predicted future crop inventories and previously measured meteorological data (e.g., previously generated weather forecasts, meteorological changes, large-scale weather models). In one embodiment, the inputs are transmitted from the sensors 104 and external data sources 112 to the moisture content predictor 106 via a network (e.g., pushed to or pulled by the moisture content predictor 106). The inputs may be transmitted periodically (e.g., every x seconds), on-demand (e.g., in response to a request from the moisture content predictor 106), or automatically (e.g., as the inputs become available).

In step 306, the moisture content predictor 106 estimates the current and future moisture content of the one or more crops, based on the inputs obtained in step 304. In one embodiment, the moisture content predictor 106 uses the inputs as inputs into one or more models that estimate moisture content in a manner that is specific to the particular crop(s), to the geographical location in which the particular crop(s) is grown/harvested, and/or other factors. For instance, the models discussed by Atzema may be employed to estimate the current and/or future moisture content.

In step 308, the harvest optimizer obtains a contract or market condition for export of a crop (e.g., grain, hay, cereal, etc.). For example, the contract or market condition may specify a volume of the crop that is required at a specific location at a specific time, or a current or estimated future market price per unit of the crop. The contract or market condition may be obtained from the set of business rules 110 and/or from the external data sources 112.

In step 310, the harvest optimizer 108 generates a recommended harvest schedule, based in part on the estimated moisture content generated by the moisture content predictor and on the contract or market condition. In one embodiment, the recommended harvest schedule is framed as a mathematical optimization problem, in which predicted future crop inventory is optimized to meet the conditions of the contract or market condition while maximizing profit. In one embodiment, after discretizing time, the optimization problem is framed as a mixed integer problem and solved using appropriate solvers. The variables in the mixed integer problem represent all of the decisions that need to be made, such as the movement and loading of vehicles for transporting the crop and the quantities of the crop to be harvested in each time period. For instance, in one embodiment, the harvest schedule recommends when (e.g., a window of time within which) to harvest the one or more crops to maintain optimal moisture content. The harvest schedule may additionally include a recommended route by which to transport the one or more crops to maintain optimal moisture content.

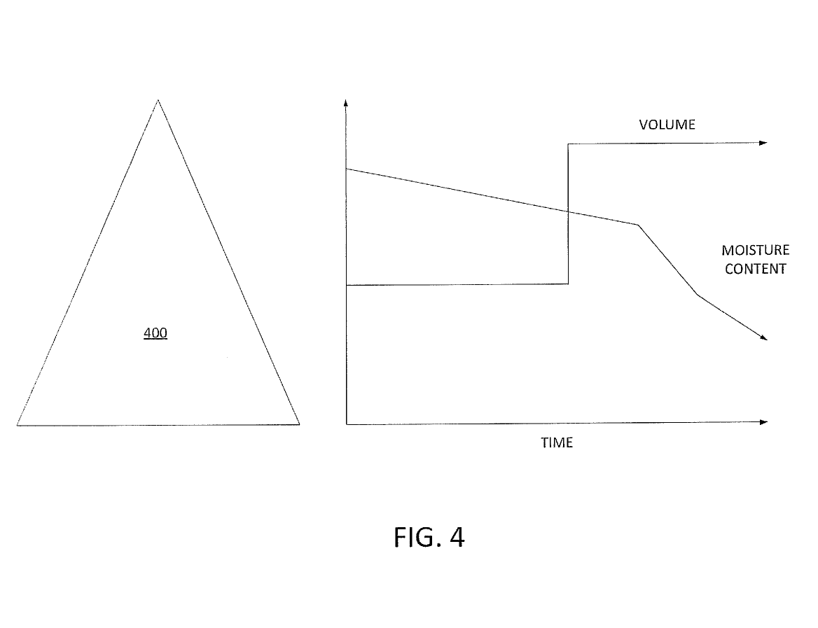

In one embodiment, the harvest optimizer 108 models each source of the crops according to the volume of the crop and the crop's moisture content across time, using the estimated moisture content generated by the moisture content predictor 106. For example, FIG. 4 illustrates a graphic representation of a single crop source 400 and an example graph charting the single crop source's volume and moisture content over time. Using such a model for each source, and considering vehicle restrictions which may limit routes, moisture content, and other constraints, the harvest optimizer may plan a route for a vehicle that dictates the time and order in which the vehicle should visit each source to accept the sources crops for transport.

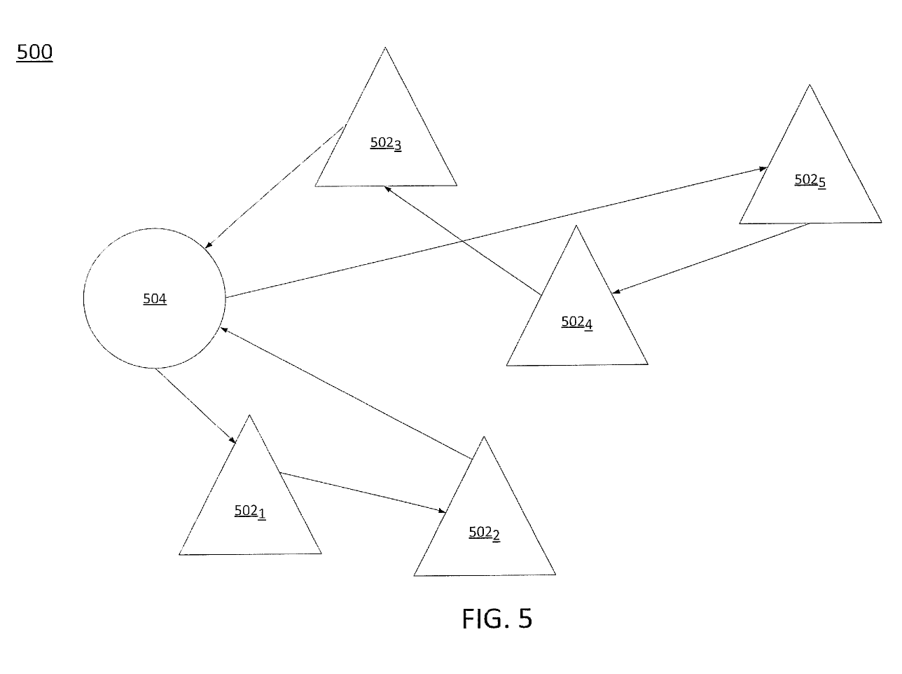

FIG. 5, for instance, illustrates an example vehicle route 500 that dictates an order in which a vehicle should visit five different sources 502₁-502₅ (hereinafter collectively referred to as “sources 502”) to accept crops for transport and delivery to a destination 504 (e.g., a storage facility, a market, or other location). Each of the sources 500 is modeled in a manner similar to the source 400 of FIG. 4, such that the volume and moisture content over time of the crop at the source can be estimated and accounted for in the route 500.

As illustrated, a route recommended by the harvest optimizer 108 may result in a path in which the sources 502 are visited in an order that is non-intuitive, at least geographically speaking. A goal of the route 500 is to maintain the optimal moisture content of the crops from each source 502 during transport and storage, while also accounting for other vehicle routing constraints (e.g., fuel, mileage, and/or personnel costs, speed limits, vehicle capacity, etc.). Thus, the vehicle may visit a subset of the sources 502, transport the crops from the subset to the destination 504, and then visit the remaining sources 502 to accept and deliver the rest of the crops. One reason for this ordering may be to maximize the monetary value of each crop at the time that it is delivered to the destination 504, while avoiding incurring additional transport or storage costs that cannot be offset by the maximized profits on the crops. Thus, the most feasible recommendations for harvesting and transporting crops are those that meet contractual obligations while respecting vehicle restrictions, crop quantities and moisture contents at locations, limits on moisture content for transportation, and other constraints that may be relevant to a particular situation.

Referring back to FIG. 3, in step 312, the harvest optimizer 108 outputs the recommended harvest time and transport route (e.g., to a human operator or to machinery responsible for the harvesting and transportation). The recommended harvest time and transport route may also be stored, e.g., locally or in the external data sources, and used or referenced in making future or updated recommendations.

Once the recommended harvest time and transport route have been output or delivered, the method 300 returns to step 304 and awaits the receipt of new inputs from the sensors 104 and/or external data sources 112.

Thus, the system 100 and methods 200 and 300 may operate in conjunction to estimate a location and a time to harvest grain and other crops in order to maintain an optimal moisture content for transportation and storage. By considering dynamic conditions, such as local business and weather conditions, on a fine-grained level, embodiments of the invention are able to maximize profit while respecting constraints on storage, transportation, costs, and other factors. Moreover, embodiments of the invention can consider these factors for multiple different crops, and generate a recommended schedule to harvest, transport, and store the different crops.

The flowchart and block diagrams in the Figures illustrate the architecture, functionality, and operation of possible implementations of systems and methods according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

Examples of the present disclosure may be a system, a computer-implemented method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

FIG. 6, for example, depicts a high-level block diagram of a computer 600 that can be transformed into a machine capable of performing the functions described herein. The computer 600 may comprise, for example, part of the harvest planner 102 discussed above in connection with FIG. 1. Notably, no computer or machine currently exists that performs the functions as described herein. As a result, the examples of the present disclosure improve the operation and functioning of the general-purpose computer to adaptively placing weather sensors in response to dynamic local conditions, as disclosed herein.

As depicted in FIG. 6, the computer or system 600 comprises a hardware processor element 602 (e.g., a central processing unit (CPU), a microprocessor, or a multi-core processor), a memory 604, e.g., random access memory (RAM) and/or read only memory (ROM), a module 605 for optimizing grain collection based on estimated moisture content, and various input/output devices 606 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the general-purpose computer may employ a plurality of processor elements. Furthermore, although only one general-purpose computer is shown in the figure, if the method(s) as discussed above is implemented in a distributed manner for a particular illustrative example, i.e., the steps of the above method(s) or the entire method(s) are implemented across multiple general-purpose computers, then the general-purpose computer of this figure is intended to represent each of those multiple general-purpose computers.

It should be noted that the present disclosure can be implemented in software and/or in a combination of software and hardware, e.g., using application specific integrated circuits (ASIC), a general purpose computer or any other hardware equivalents, e.g., computer readable instructions pertaining to the respective systems and/or methods discussed above can be used to configure a hardware processor to perform the steps functions and/or operations of the above disclosed systems and methods. In one embodiment, instructions and data for the present module or process 605 for optimizing grain collection based on estimated moisture content (e.g., a software program comprising computer-executable instructions) can be loaded into memory 604 and executed by hardware processor element 602 to implement the steps, functions or operations as discussed above in connection with the exemplary system 100 and/or methods 200 and 300. The processor executing the computer readable or software instructions relating to the above described method(s) can be perceived as a programmed processor or a specialized processor. As such, the present module 605 for optimizing grain collection based on estimated moisture content (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server. In addition, it should be noted that the hardware processor can be configured or programmed to cause other devices to perform one or more operations as discussed above. In other words, the hardware processor may serve the function of a central controller directing other devices to perform the one or more operations as discussed above.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A computer-implemented method, comprising:
obtaining a set of data indicating a local condition in a geographic location of a crop to be harvested;
estimating a moisture content of the crop to be harvested, based on the set of data;
balancing the moisture content against at least one economic constraint in order to maximize a monetary value of the crop to be harvested, using an optimization problem;
generating a plan for harvesting the crop to be harvested by solving the optimization problem, wherein the plan includes a recommended window of time within which to harvest the crop to be harvested.

2. The computer-implemented method of claim 1, wherein the plan further includes a route by which to transport the crop to be harvested to a destination.

3. The computer-implemented method of claim 2, wherein the route includes at least one stop to receive another crop in addition to the crop to be harvested.

4. The computer-implemented method of claim 1, wherein the set of data includes a sensor reading indicative of a current weather condition at the geographic location of the crop to be harvested.

5. The computer-implemented method of claim 1, wherein the set of data includes a prior prediction relating to a weather condition at the geographic location of the crop to be harvested.

6. The computer-implemented method of claim 1, wherein the set of data includes an estimated quality of the crop to be harvested.

7. The computer-implemented method of claim 1, wherein the set of data includes an estimated yield of the crop to be harvested.

8. The computer-implemented method of claim 1, wherein the set of data includes a business condition relating to the crop to be harvested.

9. The computer-implemented method of claim 1, wherein the moisture content is a current moisture content of the crop to be harvested.

10. The computer-implemented method of claim 1, wherein the moisture content is a future moisture content of the crop to be harvested.

11. The computer-implemented method of claim 1, wherein the at least one economic constraint comprises a contractual obligation relating to an export of the crop to be harvested.

12. The computer-implemented method of claim 1, wherein the at least one economic constraint comprises a market condition for the crop to be harvested.

13. The computer-implemented method of claim 1, wherein the at least one economic constraint comprises a cost for storing the crop to be harvested.

14. The computer-implemented method of claim 1, wherein the at least one economic constraint comprises a cost for transporting the crop to be harvested.

15. The computer-implemented method of claim 1, wherein the at least one economic constraint comprises a cost for drying the crop to be harvested.

16. The computer-implemented method of claim 1, wherein variables of the optimization problem comprise decisions to be made in relation to the harvesting.

17. The computer-implemented method of claim 16, wherein the decisions include a quantity of the crop to be harvested that should be harvested during a specified time period.

18. The computer-implemented method of claim 16, wherein the decisions include a loading of a vehicle to transport the crop to be harvested.

19. A machine-readable storage medium encoded with instructions executable by a processor, the machine-readable storage medium comprising:
instructions to estimate a moisture content of a crop to be harvested, based on a set of data indicating a local condition in a geographic location of the crop to be harvested;
instructions to balance the moisture content against at least one economic constraint in order to maximize a monetary value of the crop to be harvested, using an optimization problem; and
instructions to generate a plan for harvesting the crop to be harvested by solving the optimization problem, wherein the plan includes a recommended window of time within which to harvest the crop to be harvested.

20. A system, comprising:
a set of rules identifying at least one economic constraint relating to a crop to be harvested; and
a processor for estimating a moisture content of the crop to be harvested, in response to a measured set of data indicating a local condition in a geographic location of the crop to be harvested, for balancing the moisture content against the at least one economic constraint in order to maximize a monetary value of the crop to be harvested, using an optimization problem, and for generating a plan for harvesting the crop to be harvested by solving the optimization problem, wherein the plan includes a recommended window of time within which to harvest the crop to be harvested.
